(19) United States
(12) Patent Application Publication
(10) Pub. No.: US 2016/0219898 A1
(43) Pub. Date: Aug. 4, 2016

(54) S'MORE HOLDER

(71) Applicant: Jonathan Strattan, Costa Mesa, CA (US)

(72) Inventor: Jonathan Strattan, Costa Mesa, CA (US)

(21) Appl. No.: 14/612,793

(22) Filed: Feb. 3, 2015

(51) Int. Cl. A23G 1/00; A23G 1/04; A23G 1/54

(52) U.S. Cl. CPC A23G 1/0006; A23G 1/54; A23G 1/04; A23V 2002/00

(57) ABSTRACT

A s'more holder may have a gripping portion and a handle connected therebetween with a shaft. The gripping portion holds the components of the s'more so that the camper can rotate the components of the s'more in a campfire. The gripping portion has an upper cover and a lower support pivotally attached to each other. The upper cover and the lower support are spaced apart from each other so that a marshmallow disposed therebetween pushes the upper cover and lower support away from each other when the gripping portion is in the closed position to place the components of the s'more under compression and prevent rattling of the components of the s'more within the gripping portion as the camper rotates the gripping portion in the campfire.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The various embodiments and aspects described herein relate to a s'more holder.

Various devices exist in the prior art for aiding a camper in cooking a s'more. Unfortunately, these prior art devices suffer from various deficiencies.

Accordingly, there is a need in the art for an improved s'more holder.

### BRIEF SUMMARY

A s'more holder is disclosed herein. The s'more holder may have a gripping portion that captures components of a s'more so that a camper can rotate the components within a campfire. The marshmallow applies outward pressure to spread apart an upper cover and a lower support of the gripping portion so that the components of the s'more are placed under compression to prevent rattling of the components of the s'more as the camper rotates the gripping portion around in a campfire. The smore holder may also have a shaft and a handle at a distal end portion thereof. The gripping portion may be attached to the opposite end of the shaft.

More particularly, a smore holder for heating marshmallow, a piece of chocolate and two pieces of graham cracker with the marshmallow disposed therebetween is disclosed. The holder may comprise a handle, gripping portion, a shaft and a locking mechanism. The handle provides an area where a user can grasp the handle and manipulate the marshmallow and two pieces of graham crackers over a fire without burning his or her fingers. The gripping portion is traversable between an open position and a closed position. In the open position, the marshmallow, chocolate and the two pieces of graham crackers are insertable or removable from the gripping portion. In the closed position, the marshmallow and the two pieces of graham crackers cannot be removed from the gripping portion.

The gripping portion may have a lower support and an upper cover. The lower support may cradle one of the crackers when the gripping portion is traversed to the open position so that the user can position the marshmallow, chocolate and the other cracker on top of the marshmallow. The upper cover may be pivoted about the lower support for retaining the marshmallow, chocolate and the two pieces of graham crackers when the gripping portion is in the closed position as the user rotates the gripping portion upside down.

The locking mechanism may be placed in tension by compressing the marshmallow when the gripping portion is in the closed position. The shaft may define opposed first and second distal end portions. The first distal end portion of the shaft may be attached to the handle. The second distal end portion may be attached to the gripping portion. A length of the shaft may be sufficiently long so that the gripping portion may be disposed within the fire to melt the marshmallow and chocolate and toast the cracker (e.g., graham) but not burn a hand of the user gripping the handle.

In another aspect, a device for holding a resilient compressible food product between first and second edible flat food products over a fire to heat the compressible food product and the first and second edible flat food products is disclosed. The device may comprise a first holding member, a second holding member and a handle.

The first holding member may have a first cavity for holding the first edible flat food product. The second holding member may have a second cavity for holding the second edible flat food product. The second holding member may be pivotably attached to the first holding member. The handled may be attached to at least the first and/or second holding members for positioning the first and second holding members over the fire. The first and second holding members may be traversed between open and closed positions. The first and second holding members may be spaced apart by a first distance when the first and second holding members are traversed to the closed position. The first distance may be less than a thickness of the two edible flat food products and the compressible food product

The first holding member may define proximal and distal end portions. The distal end portion of the first holding member may be pivotally attached to the second holding member. The proximal portion of the first holding member may be secured to the second holding member for maintaining the first and second holding members in the closed position.

The first and second holding members may be fabricated from a wirerod. The wirerod of the first and/or second holding members may have a serpentine configuration so that the user can grip the two edible flat food products for removal without touching the wirerod with an index and thumb when the first and second holding members are traversed to the opened position.

The first and second holding members may be pivotable to each other about pivot axes. The pivot axes may be a first distance away from each other.

A pivot joint having two apertures parallel to each other provides for the pivotal action between the first and second holding members. The first and second holding members may each have wire rods at distal end portions thereof that are inserted into the two apertures of the pivot joint. The wire rods may be rotatable within the two apertures.

The locking mechanism may be a hook attached to the second holding member clipable under a proximal portion of the first holding member.

The compressible food product may be a marshmallow and the edible flat food product may be a cracker.

In another aspect, a method of using a s'more holder is disclosed. The method may comprise the steps of traversing a gripping portion of a smore holder to an opened position; inserting a first cracker into a lower support of the gripping portion; laying a marshmallow on top of the first cracker; laying a second cracker on top of the marshmallow; traversing the gripping portion toward a closed position; compressing the marshmallow; and engaging a hook of a latching mechanism to a shaft of the smore holder with the compressed marshmallow providing an opposing force to maintain the latching mechanism in a locked position as a user of the smore holder rotates the gripping portion over a campfire.

The traversing step may include the step of rotating an upper cover about the lower support.

The inserting the first cracker step may include the step of placing the first cracker in a cradle formed by the lower support of the gripping portion.

The engaging the hook step may include the step of pushing a hook under the shaft of the smore holder and releasing the hook to allow the expansive force of the marshmallow to retain the hook on the shaft.

The method may also further comprise the step of attaching a first part of the shaft to a second part of the shaft to assemble the smore holder.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a smore holder with components of a smore disposed within a gripping portion of the smore holder;

FIG. 2 is an enlarged perspective view of the gripping portion, locking mechanism and a shaft of the smore holder shown in FIG. 1;

FIG. 3 is a front plane view of the gripping portion shown in FIG. 2;

FIG. 4 is a side plane view of the gripping portion and the locking mechanism shown in FIG. 2; and

FIG. 5 is a top view of the gripping portion traversed to an opened position.

### DETAILED DESCRIPTION

Referring now to the drawings, a s'more holder 10 for holding a s'more 12 is disclosed. The s'more holder 10 is operative to allow a camper to grip a handle 14 to hold a gripping portion 16 over a campfire to heat up and at least partially melt a marshmallow 18 and chocolate 20 disposed between two graham crackers 22. The gripping portion 16 is held in place by a spring force of the marshmallow 18 that retains a latching mechanism 24 against a shaft 26 of the s'more holder 10. The marshmallow 18 pushes a lower support 28 and an upper cover 30 apart from each other while the latching mechanism 24 provides an equal and opposing force in order to retain the graham crackers 22, chocolate 20 and marshmallow 18 between the lower support 28 and the upper cover 30. This prevents the graham crackers 22, chocolate 20 and marshmallow 18 from rattling inside the gripping portion 16 as the camper rotates the gripping portion 16 and the components of the s'more 12 around in the campfire.

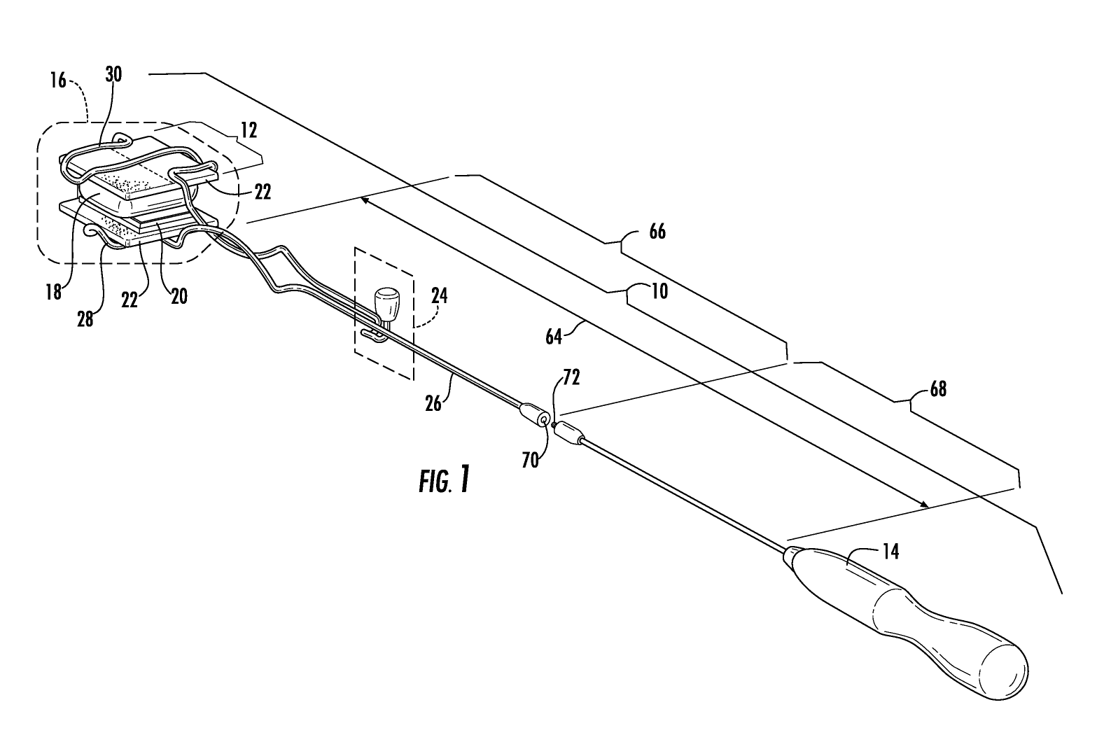

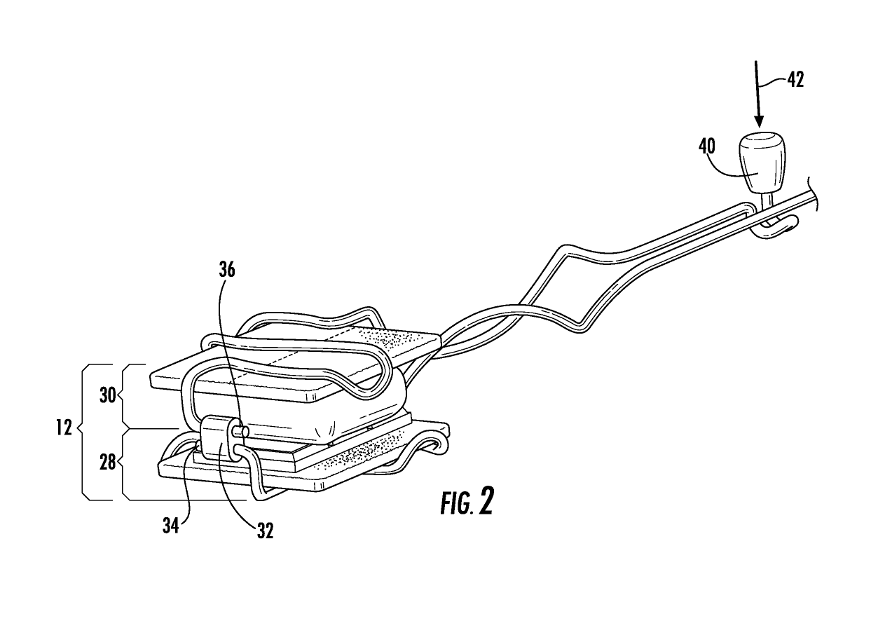

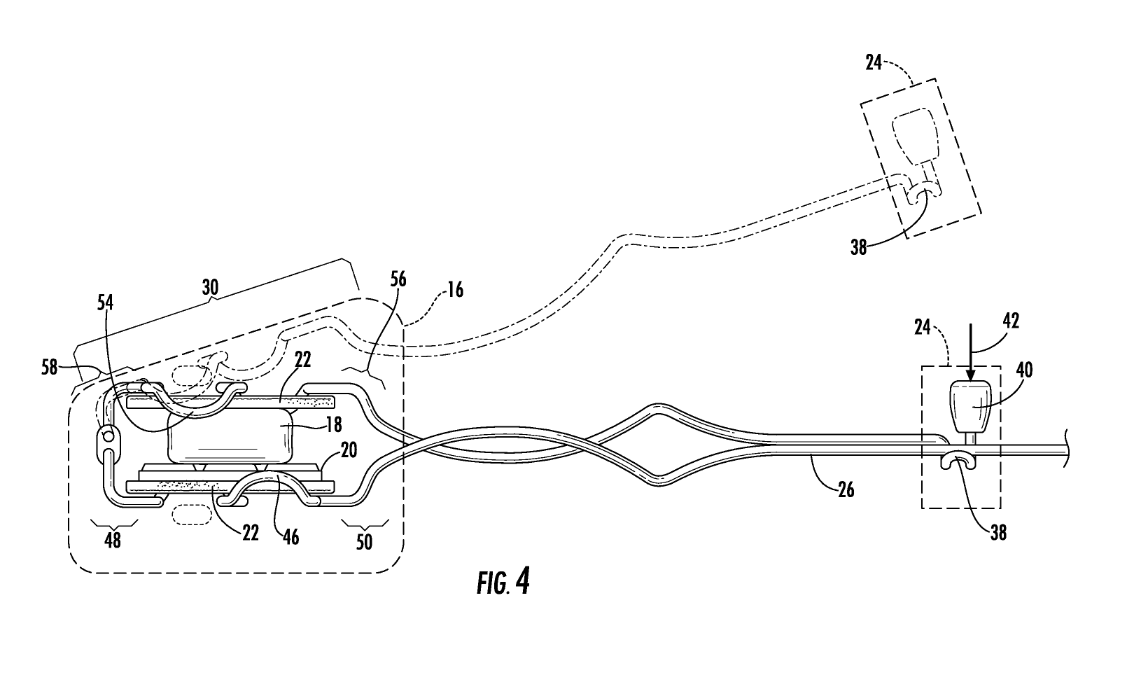

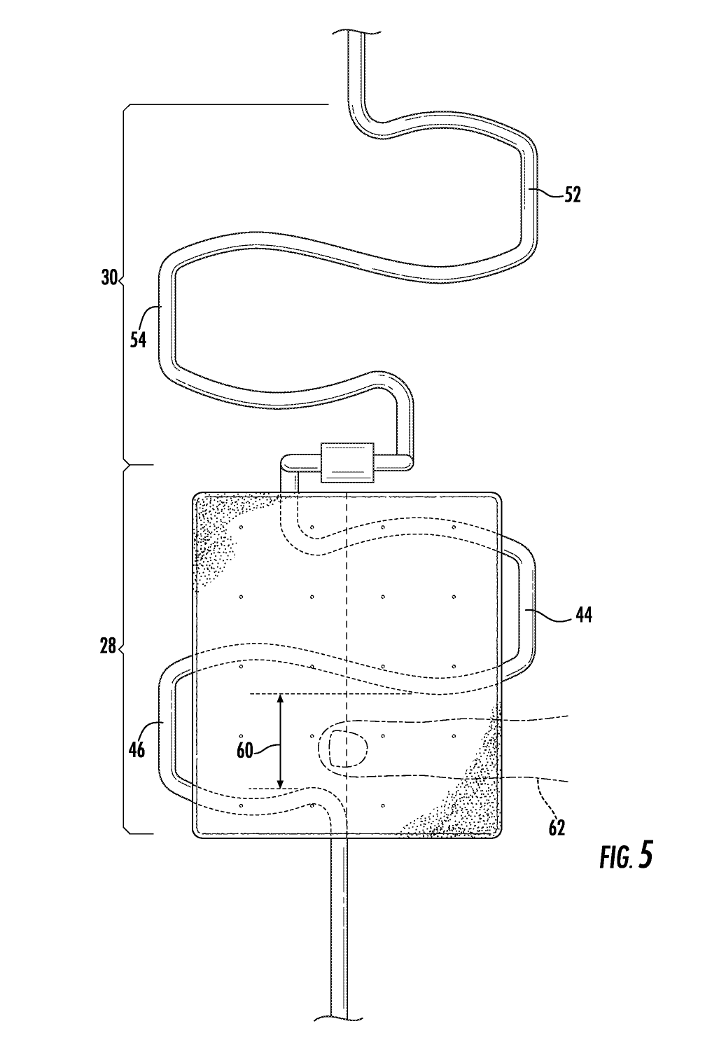

Referring now to FIGS. 1 and 2, the upper cover 30 and the lower support 28 are pivotally attached to each other through joint 32. The upper cover 30 and the lower support 28 may be fabricated from a wire rod and shaped in order to hold the components of the s'more 12 therebetween 28, 30. Distal end portions 34, 36 of the wire rods for the upper cover 30 and the lower support 28 may be bent so as to be parallel with each other and be disposed within apertures of the joint 32. Distal ends of the distal end portions 34, 36 of the lower support 28 and upper cover 30 may be enlarged in order to prevent removal of the distal end portions 34, 36 of the lower support 28 and the upper cover 30 from the joint 32. The joint 32 may be fabricated from a stainless steel or plastic material such as through injection molding or other processes known in the art or developed in the future. The distal end portions 34, 36 of the lower support 28 and upper cover 30 may be rotatable within the joint 32 so that the lower support is pivotably attached to the upper cover 30. During use, the upper cover 30 may have two different positions, namely, a closed position which is shown in FIGS. 1 and 2 and an opened position which is shown in FIG. 5. FIG. 4 illustrates the upper cover as it is transitioned to the opened position in phantom lines. In the closed position, the s'more 12 is retained between the lower support 28 and the upper cover 30 so that the camper can position the s'more 12 over the campfire as well as rotate the s'more 12 360° in order to provide for even heating about the s'more 12. In the opened position, the camper may remove the heated s'more 12 for consumption.

The latching mechanism 24 may extend from the upper cover 30 and form a hook 38 that is operative to be hooked under the shaft 26 when traversing the upper cover 30 to the closed position. When the marshmallow 18 is not disposed in the gripping portion 16, the s'more holder 10 may be sized and configured so that the hook 38 can be freely unlatched from the shaft 26. However, when the marshmallow 18 is disposed in the gripping portion 16, the marshmallow is sufficiently large in order to push the graham crackers 22 and the upper cover 30 and lower support 28 away from each other in order to engage the latching mechanism 24, and specifically, the hook 38 to the shaft 26 so that the latching mechanism 24 is retained to the shaft 26. In this manner, the s'more 12 is firmly retained in the gripping portion 16 and does not rattle around in the gripping portion as a user manipulates the s'more 12 and the gripping portion 16 over the campfire.

Although it is preferred that the hook 38 be freely detachable from the shaft 26 when the marshmallow 18 is not present in the gripping portion 16, it is also contemplated that even without any edible food product disposed between the lower support 28 and the upper cover 30, the latching mechanism 24 is not freely disengageable from the shaft 26. Instead, some downward force may be required to push the latching mechanism 24 downward with handle 40 in the direction of arrow 42 so that the hook 38 clears the shaft 26 and the hook 38 may be laterally moved in order to unlatch the latching mechanism from the shaft 26 and traverse the upper cover 30 to the opened position.

The handle 40 may be fabricated from an insulation material such as wood or other materials known in the art or developed in the future. The handle 40 may protect the camper's hand from burns as the heat from the campfires is conducted through the wire rod of the s'more holder 10.

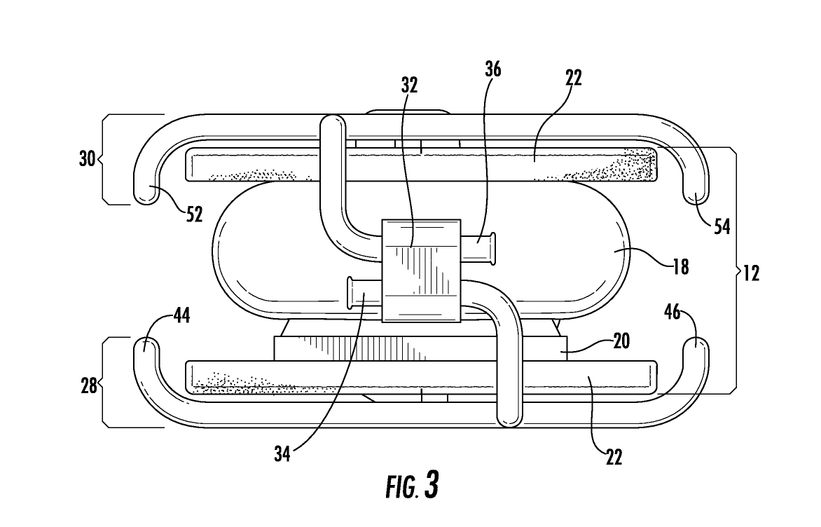

The lower support 28, as discussed above, may be fabricated from a wire rod material. The wire rod 28 may be shaped to cradle the one or more components of the s'more 12 thereon. When loading the s'more holder 10, the user traverses the upper cover 30 to the opened position. With the upper cover 30 traversed to the opened position, the camper has access to the lower support 28 in order to load the components of the s'more 12 thereon. As shown in FIGS. 3-5, lateral sides 44, 46 may be bent slightly upward in order to prevent the components of the s'more 12 from falling off laterally. The front and back portions 48, 50 of the lower support 28 may be curved upward in order to prevent the components of the s'more 12 from falling off from the front or back. Primarily, the front and back portions 48, 50 and the lateral sides 44, 46 of the lower support 28 are designed to hold the bottom cracker 22 in place. The other component, namely, the marshmallow 18 and piece of chocolate 20 may be retained in place by friction with the other components of the s'more 12. However, the upward extension of the front and back portions 48, 50 and the lateral sides 44, 46 may be sufficiently high to also trap the chocolate 20 and marshmallow 18.

The upper cover 30 may have a substantially similar configuration as the lower support 28 in order to cradle one or more components of the s'more 12 within the upper cover 30. As discussed above, the gripping portion 16 is manipulated or turned 360° in order to provide even heating to the s'more 12 as the camper attempts to melt the chocolate 20 and the marshmallow 18. In particular, the lateral sides 52, 54 of the upper cover 30 may extend downward, as shown in FIGS. 3-5. The front and back portions 56, 58 may also be curved downward. The front and back portions 56, 58 and the lateral sides 52, 54 of the upper cover 30 help to retain the cracker 22 in place. As discussed above, for the other components of the s'more 12, namely, the marshmallow 18 and the chocolate 20, friction holds these components 18, 20 in place. However, the lower extension of the front and back portions 56, 58 and the lateral sides 52, 54 may be sufficiently low in order to trap the marshmallow 18 and chocolate 20. Moreover, the compression of the marshmallow 18 prevents rattling of the components of the s'more 12 within the gripping portion 16 of the s'more holder 10.

After the user has heated the s'more 12, the user may disengage the latching mechanism 24 by pressing downward on the handle 40 in the direction of arrow 42. The handle 40 is then traversed slightly laterally in order to unhook the hook 38 from the shaft 26. The upper cover 30 is then traversed to the opened position, as shown in FIG. 5. The lower support 28, as discussed above, is fabricated from a wire rod material. The wire rod material may be shaped in order to provide for an opening 60 wide enough for a finger 62 of the camper to fit therebetween. In this manner, the camper can remove the s'more 12 by gripping the two crackers 22 without touching or contacting the hot wire rod of the lower support 28. Since the s'more 12 is removed from the gripping portion 16 immediately after being removed from the fire, it is crucial that the finger 62 not contact the heated wire rod of the lower support 28 to prevent burning. Additionally, since the finger 62 of the camper can fit within the opening 60, such configuration is beneficial because the camper can now use his or her opposable thumb in order to remove the s'more 12.

The shaft 26 may have a length 64 sufficiently long so that the gripping portion 16 is extended away from the handle 14 to prevent burning of the camper's hand from the campfire as the camper heats the s'more 12 over the campfire. The shaft 26 may be formed from two parts, namely, a first part 66 and a second part 68. The first and second part 66, 68 may be removably attachable to each other through a threaded hole 70 and threaded stud 72. When the s'more holder 10 is not in use, the camper may disassemble the first and second parts 66, 68 in order to reduce the size of the s'more holder 10.

As used herein, a s'more 12 comprises first and second graham crackers 22 with marshmallow 18 and chocolate disposed therebetween 22. However, a s'more 12 may also consists of two crackers (not necessarily graham crackers) with at least a compressible edible food product disposed between the two crackers. In our example, the compressible edible food product is a marshmallow 18. Moreover, even though a compressible edible food product (e.g., marshmallow) is optimally disposed between the crackers 22, non-compressible food products may also be disposed between the crackers 22. Additionally, although crackers 22 are used in our example to describe the various aspects and embodiments of the s'more holder 10, other flat edible food products may be used in lieu of the crackers 22.

The above description is given by way of example, and not limitation. Given the above disclosure, one skilled in the art could devise variations that are within the scope and spirit of the invention disclosed herein, including various ways of forming the handles. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A smore holder for heating marshmallow and two pieces of graham cracker with the marshmallow disposed therebetween, the holder comprising:
a handle so that a user can grasp the handle and manipulate the marshmallow and two pieces of graham crackers over a fire;
a gripping portion that is traversable between an open position and a closed position, in the open position, the marshmallow and the two pieces of graham crackers are insertable or removable from the gripping portion, and in the closed position, the marshmallow and the two pieces of graham crackers cannot be removed from the gripping portion, the gripping portion having:
a lower support that cradles one of the crackers when the gripping portion is traversed to the open position so that the user can position the marshmallow and the other cracker on top of the marshmallow;
an upper cover pivotable about the lower support for retaining the marshmallow and the two pieces of graham crackers when the gripping portion is in the closed position as the user rotates the gripping portion upside down;
a locking mechanism placed in tension by compressing the marshmallow when the gripping portion is in the closed position;
a shaft defining opposed first and second distal end portions, the first distal end portion of the shaft attached to the handle and the second distal end portion attached to the gripping portion, a length of the shaft is sufficiently long so that the gripping portion may be disposed within the fire to melt the marshmallow but not burn a hand of the user gripping the handle.

2. A device for holding a resilient compressible food product between first and second edible flat food products over a fire to heat the compressible food product and the first and second edible flat food products, the device comprising:
a first holding member having a first cavity for holding the first edible flat food product;
a second holding member having a second cavity for holding the second edible flat food product, the second holding member pivotably attached to the first holding member;
a handle attached to at least the first and/or second holding members for positioning the first and second holding members over the fire;
wherein the first and second holding members are traverseable between open and closed positions, the first and second holding members being spaced apart by a first distance when the first and second holding members are traversed to the closed position, the first distance being less than a thickness of the two edible flat food products and the compressible food product.

3. The device of claim 2 wherein the first holding member defines proximal and distal end portions, the distal end portion of the first holding member pivotally attached to the second holding member, the proximal portion of the first holding member securable to the second holding member for maintaining the first and second holding members in the closed position.

4. The device of claim 2 wherein at least one of the first and second holding members are fabricated from a wirerod, the wirerod of the first and/or second holding members having a serpentine configuration so that the user can grip the two edible flat food products for removal without touching the wirerod with an index and thumb when the first and second holding members are traversed to the opened position.

5. The device of claim 2 wherein the first and second holding members are pivotable to each other, the pivot axes disposed a first distance away from each other.

6. The device of claim 2 further comprising a pivot joint having two apertures parallel to each other, and the first and second holding members each have wire rods at distal end portions thereof that are inserted into the two apertures of the pivot joint, the wire rods being rotatable within the two apertures.

7. The device of claim 2 wherein a proximal portion of the second holding member is a hook clipable under a proximal portion of the first holding member.

8. The device of claim 2 wherein the compressible food product is a marshmallow and the edible flat food product is a cracker.

9. A method of using a s'more holder, the method comprising the steps of:
traversing a gripping portion of a smore holder to an opened position;
inserting a first cracker into a lower support of the gripping portion;
laying a marshmallow on top of the first cracker;
laying a second cracker on top of the marshmallow;
traversing the gripping portion toward a closed position;
compressing the marshmallow;
engaging a hook of a latching mechanism to a shaft of the smore holder with the compressed marshmallow providing an opposing force to maintain the latching mechanism in a locked position as a user of the smore holder rotates the gripping portion over a campfire.

10. The method of claim 9 wherein the traversing step includes the step of rotating an upper cover about the lower support.

11. The method of claim 9 wherein the inserting the first cracker step includes the step of placing the first cracker in a cradle formed by the lower support of the gripping portion.

12. The method of claim 9 wherein the engaging the hook step includes the step of pushing a hook under the shaft of the smore holder and releasing the hook to allow the expansive force of the marshmallow to retain the hook on the shaft.

13. The method of claim 9 further comprising the step of attaching a first part of the shaft to a second part of the shaft to assemble the smore holder.
